(19) United States
(12) Patent Application Publication
(10) Pub. No.: US 2026/0243731 A1
(43) Pub. Date: Aug. 20, 2026

(54) METHODS AND SYSTEMS FOR ULTRASONIC DETECTION OF CORROSION

(71) Applicant: Triad National Security, LLC, Los Alamos, NM (US)

(72) Inventors: Eric Sean Davis, Los Alamos, NM (US); Gonzalo Seisdedos Rodriguez, Los Alamos, NM (US); Tommy Rockward, Los Alamos, NM (US); Milo Guy Prisbrey, Los Alamos, NM (US); Cristian Pantea, Los Alamos, NM (US)

(21) Appl. No.: 19/456,229

(22) Filed: Jan. 22, 2026

Related U.S. Application Data
(60) Provisional application No. 63/760,784, filed on Feb. 20, 2025.

(51) Int. Cl. G01N 29/07; G01N 29/44

(52) U.S. Cl. CPC G01N 29/07; G01N 29/4418; G01N 2291/011; G01N 2291/0234; G01N 2291/101

(57) ABSTRACT

Ultrasound corrosion detection in corrosive dynamic environments and corrosion systems employing ultrasound corrosion detection for non-destruction detection of internal corrosion are provided herein. An example method includes coupling one or more transducers to a corrosive system where a metallic component is being corroded, emitting, by at least one of the one or more transducers, acoustic waves to excite the metallic component across a range of ultrasonic frequencies; receiving, by at least one of the one or more transducers, signals generated by the excited metallic component; and processing the signals generated by the excited metallic component to detect one or more of a presence of corrosion, a lack of corrosion, a corrosion location, or a corrosion extent in the metallic component, such as a bipolar plate in an electrolyte system.

### CROSS REFERENCE TO RELATED APPLICATIONS

This application claims priority to U.S. Provisional Application No. 63/760,784, entitled “METHODS AND SYSTEMS FOR ULTRASONIC DETECTION OF CORROSION”, filed Feb. 20, 2025, the entirety of which is incorporated by reference herein for all purposes.

### STATEMENT REGARDING GOVERNMENT SUPPORT

This invention was made with government support under 89233218CNA000001 awarded by the National Nuclear Security Administration. The government has certain rights in the invention.

### TECHNOLOGICAL FIELD

Example embodiments of the present disclosure relate generally to non-destructive assessment of internal metallic structures, and more particularly, to ultrasonic detection of corrosion in corroding systems in dynamic environments.

### BACKGROUND

Corrosion can negatively affect any structure containing corroding materials, especially if harmful cations are released in sizable quantities. For example, a pipe, barrel, drum, or any other vessel for storing and/or transporting radioactive waste or hazardous waste may be negatively affected by corrosion. An electrochemical system (such as a battery, an electrolyzer, a capacitor, a solar cell, an electrochemical cell, a flow battery, or a fuel cell) is another example of a corroding system. These systems may include various metallic or coated metallic components. For example, a fuel cell is an electrochemical cell that uses chemical energy of a fuel and an oxidizing agent to produce electricity. Fuel cells may include various metallic or coated metallic components, such as metallic bipolar plates. For example, proton exchange membrane fuel cells (PEMFCs) frequently utilize metallic bipolar plates because they are easy to manufacture, possess excellent electrical and thermal conductivity, have strong mechanical properties, provide heat and water management, and they facilitate the collection and distribution of the electrical current generated by the electrochemical reactions occurring in the fuel cell. As another example, electrolyzers, which are electrochemical devices that use electricity to split water into hydrogen and oxygen gases through the process of electrolysis, may also contain metallic bipolar plates and electrodes. These electrochemical systems, such as fuel cells and electrolyzers, however, include a corrosive (e.g., acidic) internal environment due to, for example, different potentials and aqueous media (i.e., water), and corrosion can cause thinning of such metallic components due to the gradual degradation of its surface. The metallic bipolar plates are susceptible to corrosion due to the operating conditions, including humid and acidic environments, dynamic loading, idling, or startup-shutdown voltage spikes, which decrease their durability and performance. Such corrosion is often invisible from the exterior of these systems and can have an adverse impact on longevity, as well as short term operation. For example, in PEMFCs, such corrosion-induced degradation causes a reduction in performance over time due to decreased electrical conductivity (e.g., contamination of the membrane by released metal ions affects proton transport/conductivity; affecting the catalyst layer alters oxidation and reduction performance, and increased contact resistance results in ohmic losses and poor water management), reduced mechanical integrity (e.g., pits, cracks, and other defects), and/or contamination of the electrolyte present in the fuel cell. The inventors have identified a number of deficiencies and problems in conventional post-mortem and/or invasive methods for detecting such corrosion in corroding systems and environments. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

Various embodiments of the present disclosure are directed to methods for nondestructive ultrasonic corrosion detection and an ultrasonic corrosion diagnostic system for assessing internal corrosion of a system in dynamic environments. In accordance with some exemplary embodiments of the present disclosure, a method for non-destructive corrosion detection in a corrosive system is disclosed, the method comprising emitting one or more pulse sequences into the corrosive system from one or more first transducers positioned on an external surface of the corrosive system; receiving one or more corresponding echo sequences based on a reflection of the respective one or more pulse sequences; and processing the one or more corresponding echo sequences to detect one or more of a presence of corrosion, a lack of corrosion, a corrosion location, or a corrosion extent in one or more metallic components of the corrosive system.

In some embodiments, processing the one or more corresponding echo sequences comprises detecting differences in the corresponding echo sequences. In some further embodiments, detecting differences in the corresponding echo comprises determining a first x-axis position of a peak in a first sequence, the first x-axis position corresponding to a first travel time; determining a second x-axis position of the peak in one or more subsequent sequences, wherein the second x-axis position corresponds to a second travel time, and wherein the first x-axis position differs from the second x-axis position; and determining local corrosion of a corrosive layer of the corrosive system corresponding to the peak based on comparing the first x-axis position to the second x-axis position.

In some embodiments, one or more first transducers are ultrasonic pulse-echo transducers having a transmitting mode and a receiving mode.

In some embodiments, the corrosive system is a metallic container, a fuel cell system, a battery, an electrolyzer, a capacitor, a solar cell, an electrochemical cell, or a flow battery. In some further embodiments, the corrosive system is a fuel cell system. In still some further embodiments, the one or more corresponding echo sequences are based on the reflection of the respective one or more pulse sequences on one or more metallic or coated metallic bipolar plates of a fuel cell in the fuel cell system. In certain embodiments, emitting the one or more pulse sequences into the fuel cell system comprises emitting the one or more pulse sequences perpendicular to the one or more metallic or coated metallic bipolar plates.

In some embodiments, determining local corrosion of the corrosive layer corresponding to the peak based on comparing the first x-axis position to the second x-axis position comprises training an algorithm using machine learning to pinpoint a shifting trend in the first and the second x-axis positions.

In accordance with another exemplary embodiment, a method for non-destructive corrosion detection in a corrosive system is disclosed, the method comprising coupling one or more transducers to a portion of the corrosive system; emitting, by at least one of the one or more transducers, acoustic waves to excite a metallic component of the corrosive system across a range of ultrasonic frequencies; receiving, by at least one of the one or more transducers, signals generated by the excited metallic component; and processing the signals generated by the excited metallic component to detect one or more of a presence of corrosion, a lack of corrosion, a corrosion location, or a corrosion extent in the metallic component.

In some embodiments, processing the signals generated by the excited metallic component comprises detecting differences in the signals. In some further embodiments, detecting differences in the signals comprises determining a first x-axis position of a peak in a first signal, the first x-axis position corresponding to a first frequency; determining a second x-axis position of the peak in one or more subsequent signals, wherein the second x-axis position corresponds to a second frequency, and wherein the first x-axis position differs from the second x-axis position; determining local corrosion of the bipolar plate corresponding to the peak based on comparing the first x-axis position to the second x-axis position; determining peak properties of the signals; and determining local corrosion of the bipolar plate based on at least one of the one or more determined peak properties, such as, but not limited to, widths, shapes, appearances, and/or disappearances of the peaks. In some further embodiments, determining local corrosion of the bipolar plate corresponding to the peak based on comparing the first x-axis position to the second x-axis position comprises training an algorithm using machine learning to pinpoint a shifting trend in the first and the second x-axis positions.

In some embodiments, the same at least one of the one or more transducers is used for the emitting of the acoustic waves and the receiving of the signals.

In some embodiments, emitting, by at least one of the one or more transducers, acoustic waves comprises emitting the acoustic waves by one or more first transducers, and wherein receiving, by at least one of the one or more transducers, signals comprises receiving the signals by one or more second transducers, wherein the first and second transducers are different transducers.

In accordance with another exemplary embodiment, a system for ultrasonic corrosion detection is provided, the system comprising one or more metallic components; and one or more first transducers coupled to an external or internal surface of the system, the one more first transducers configured to emit one or more pulse sequences into the system and receive one or more corresponding echo sequences based on a reflection of the one or more pulse sequences, the corresponding echo sequences configured to detect one or more of a presence of corrosion, a lack of corrosion, a corrosion location, or a corrosion extent of at least one of the metallic components in the system.

In some embodiments, the one or more first transducers are ultrasonic pulse-echo transducers having a transmitting mode and a receiving mode.

In some embodiments, the one or more first transducers are coupled to the top, external surface of the corrosive system, the one or more first transducers configured to emit one or more pulse sequences perpendicular to the at least one metallic component.

In some embodiments, each bipolar plate comprises a first voltage lead tab and a second voltage lead tab, the second voltage lead tab positioned diagonally across the at least one metallic component from the first voltage lead tab.

In some embodiments, the system further comprises a plurality of corrosive systems, each corrosive system having at least one metallic component.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIGS. 1A-1C schematically illustrate an example corrosive system in which ultrasonic corrosion detection in accordance with various example embodiments of the present disclosure may be implemented.

FIGS. 2 and 3 depict flowcharts broadly illustrating series of steps to perform ultrasonic corrosion detection in accordance with example embodiments of the present disclosure.

FIG. 4 depicts an example experimental setup to simulate the operating environment of an example corrosive system in which example embodiments of the present disclosure may be used.

FIGS. 5A-5F depict SEM images of stainless-steel samples before and after being subjected to corrosion protocols using the example experimental setup of FIG. 4 in accordance with various example embodiments of the present disclosure.

FIGS. 6A-6L depict ultrasonic data of example ultrasonic corrosion detection of the stainless-steel samples of FIGS. 5A-5F in accordance with various example embodiments of the present disclosure.

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all, embodiments of the present disclosure are shown and described herein. Indeed, embodiments of the present disclosure may be embodied in many different forms, and accordingly this disclosure should not be construed as limited to the embodiments set forth herein; rather, these embodiments are provided so that this disclosure will satisfy applicable legal requirements.

### Overview

Detecting corrosion of materials is important for a wide range of industries due to process upsets and catastrophic failures that can happen if the corroded material fails. For example, in pipes, barrels, or any other vessels for storing and/or transporting radioactive waste or hazardous waste may be negatively affected, to the point of catastrophic failure and potential safety issues, by corrosion. In another example, in an electrochemical system, such as in active fuel cells and electrolyzers, bipolar plates, one of the major components in these systems, allow current collection, double as the pathway for the fuel or oxygen to travel through the systems, and serve as a structural support for the systems. Bipolar plates are typically metallic components, such as metal foils formed from stainless steel, titanium, or various other metals, which may be coated in some instances. Such metallic components operate inside of the electrochemical systems, where there are different potentials and aqueous media (i.e., water) that can potentially bring about a corrosive environment. Corrosion can cause thinning of such metallic components, which has an adverse impact on longevity as well as short term operation of the systems, and simply has a detrimental effect on the overall efficiency of the electrochemical systems. Real-time techniques to detect such corrosion during operation of electrochemical systems suffer from significant barriers due to the constraints inherent in a corrosive system such as a fuel cell, a corrosive test cell, or electrolyzers (e.g., low access for sensors, small footprint, limited access to only one side, etc.) and post-mortem, destructive inspection of such materials is possible, but only provides limited value. For example, electrochemical techniques, such as potentiostatic and potentiodynamic tests, electrical impedance (EIS), or linear polarization resistance cannot isolate the corrosive part of interest, require lab-type equipment and cannot be performed in-operando or in-situ. Observing a decrease in performance from one of these electrochemical techniques cannot be directly associated to corrosion or to any part of the system in particular. Surface analysis techniques (e.g., scanning electron microscopy (SEM), energy-dispersive X-ray spectroscopy (EDS), CT, optical microscopy, grains and microstructure analysis) to probe for surface defects like pits, pores, or cracks in metallic parts caused by corrosion, mass loss measurement, and quantifying metallic ions in the electrolyte or byproducts also require lab-type equipment, cannot be performed in-situ, and/or are incapable of pinpointing the corrosion source. The inventors have determined that it would be desirable and advantageous to have the ability to, in real-time and in a non-destructive manner, detect corrosion, and in some embodiments, in harsh, hazardous, and/or dynamic environments, to predict performance degradation due to corrosion ahead of time, and in some instances, to plan out intervention efforts before unacceptable performance loss.

To overcome these problems and others, various embodiments of the present disclosure are directed to methods for nondestructive ultrasonic corrosion detection and ultrasonic corrosion diagnostic systems for assessing internal corrosion in a variety of corrosive systems or corroding environments, operating as an in-situ diagnostic tool to characterize the corrosion kinetics of metallic plates in-operando. The inventors have identified two separate ultrasonic approaches to corrosion detection, pulse-echo and acoustic resonance, that when performed in accordance with various embodiments of the present disclosure, provide real-time corrosion monitoring in, for example, harsh, hazardous, and/or dynamic environments. Accordingly, various embodiments of the present disclosure enable real-time, in-situ monitoring of corrosion in corrosion-susceptible components, such as in metallic bipolar plates of an electrochemical system such as a fuel cell, a corrosion test cell, or electrolyzer, via the propagation of sound waves in the ultrasonic frequencies and the analysis of the acoustic response produced when the sound waves interact with materials inside the corrosive system, during live operation. Such embodiments of the present disclosure may allow for intervention steps to be taken to bring the corrosive system, such as a fuel cell, back into acceptable performance margins as well as to understand potential problems. For example, in a non-limiting use case of a fuel cell in a fuel cell vehicle, a fuel cell structured with ultrasonic corrosion detection in accordance with various embodiments of the present disclosure may be used to trigger a warning indication when corrosion has passed a specific margin. In other non-limiting examples, such as energy generation applications, various embodiments of the present disclosure may be used to calculate when the most economically advantageous time is to service a particular corrosion-susceptible component in a corrosive environment (i.e., when the cost from performance degradation of a particular corrosion-susceptible component is above the replacement cost of such component). For example, with various embodiments of the present disclosure, corrosion can be identified locally to a specific metallic bipolar plate in a specific fuel cell within a fuel cell system and there is no need to get rid of the entire system, which contains costly catalysts such as platinum. Therefore, instead of throwing the whole corrosive system away, example embodiments of the present disclosure allow for pinpointing where corrosion is occurring and offering mitigating strategies locally. In another non-limiting use case, various embodiments of the present disclosure can be utilized in structural health monitoring, such as indicating that one or more passivation layers are breaking down, informing a user that the underlying system may be under duress. In still other non-limiting use cases, various embodiments of the present disclosure can be utilized in locations that cannot be physically accessed or are hazardous to humans as well as aid in the development of new protective materials/coatings to increase the lifetime of mission-relevant structures.

Various embodiments of the present disclosure advantageously require access to only one side of a corrosion-susceptible component to be monitored, allowing for the other side to be exposed to the corroding environment. Some embodiments of the present disclosure may also work on the corroding side with proper shielding of the ultrasonic sensors. In still some embodiments, a completely non-contact approach is also possible, for example, if line-of-sight with the corroding component is possible.

Various embodiments of the present disclosure may employ ultrasonic methods to monitor the corrosion process of a corrosion-susceptible components, such as a metallic or coated metallic component (e.g., a bipolar plate in a fuel cell or an electrode in an electrochemical system), by evaluating changes in the sound speed and/or sound travel time due to variations in the metallic or coated metallic component (e.g., thinning, degrading, etc.). In some embodiments, multiple ultrasonic scans are performed over time, thereby providing non-destructive monitoring of the internal corrosion-susceptible components of a corrosive system based on several snapshots of the metallic components from which valuable insight into the condition or development of corrosion over time may be determined. Example embodiments provide an output of the ultrasonic data which can be used to characterize each layer in a fuel cell, for example, such as calculating positioning and distances between the various internal layers of the fuel cell or determining changes in the resonances in each layer of the fuel cell, as well as detecting corrosion of such layers. Accordingly, various embodiments of the present disclosure provide for the detection of one or more of a presence of corrosion, a lack of corrosion, a corrosion location, or a corrosion extent in one or more metallic components or other corrosion-susceptible components in a corrosive system, such as, but not limited to, a fuel cell, a corrosion test cell, or an electrolyzer.

As an in situ diagnostic technique, embodiments of the present disclosure do not hinder the performance of the underlying corrosive system(s) in any way. Indeed, in some embodiments, the application of ultrasonic energy may improve the performance of a corrosive system, such as an electrochemical system, due to resonating the surface of the bipolar plate(s) as described herein, which could facilitate water movement and help reduce potential flooding that occurs in some electrochemical stack systems.

These characteristics as well as additional features, functions, and details are described below. Similarly, corresponding and additional embodiments are also described below. The various implementations of the ultrasonic corrosion detection of the present disclosure are not limited to bipolar plates or electrodes in electrochemical systems, or even other electrochemical system corrosion-susceptible components and can instead be configured for use with other technologies that might be of interest to a user. Bipolar plates are just an example of a part that experiences corrosion and embodiments of the present disclosure can be implemented to evaluate the corrosion occurring in any metallic part on any system in a dynamic environment. That is, one of ordinary skill in the art will appreciate that the ultrasonic corrosion detection related concepts discussed herein may be applied to a wide variety of other technologies wherein embedded sensing of corrosion-susceptible components in hard-to-reach or limited access areas may be beneficial, such as, but not limited to, any metal container (e.g., metal containers such as a 55-gallon drum or other example metal container containing hazardous material may react with the hazardous material and start thinning, etc.).

### Exemplary Embodiments of the Present Disclosure

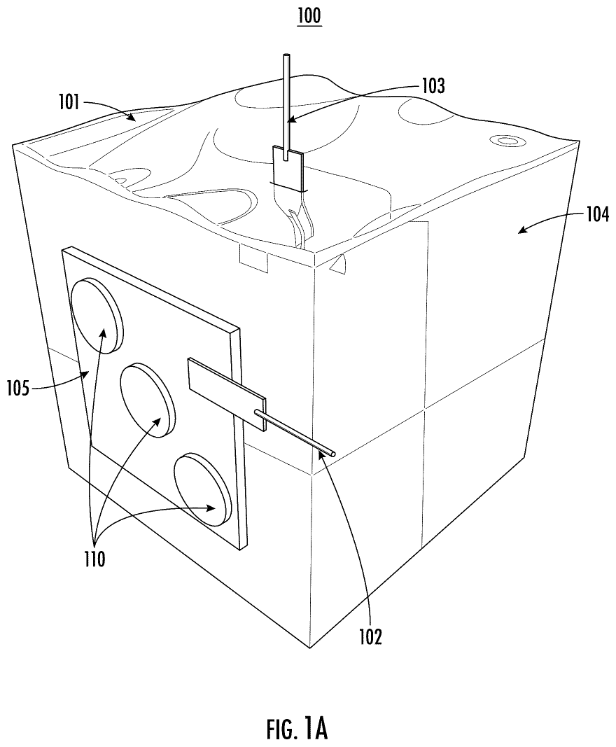

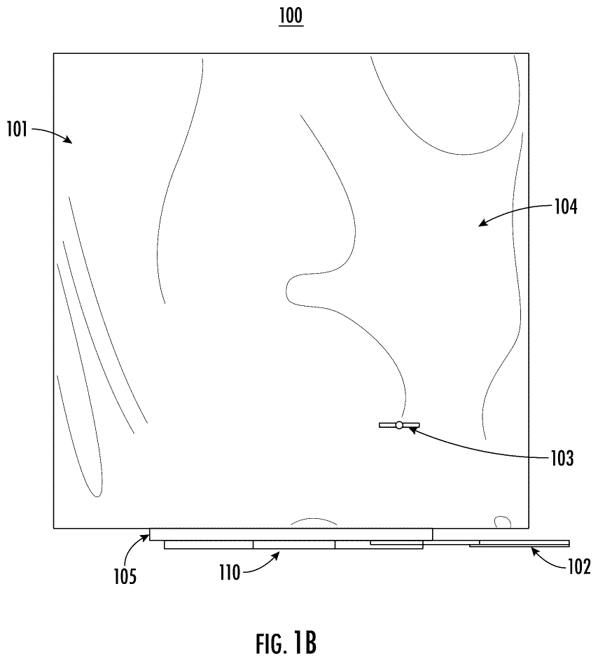

FIG. 1A shows a perspective view of an example corrosive system. For example, FIG. 1A depicts a perspective view of an example electrochemical system, such as a corrosion test cell system 100 according to various embodiments of the present disclosure. FIG. 1B shows a top view of the example corrosion test cell system 100 of FIG. 1A. FIG. 1C shows a cross-sectional view taken along line A-A of the example corrosion test cell system 100 of FIGS. 1A and 1B. As depicted in FIG. 1A, the corrosion test cell system 100, as well as other electrochemical systems like fuel cells or electrolyzers, may comprise a plurality of individual cells 101 in series or parallel to form a cell stack. In this example, each corrosion test cell 101 comprising an anode 102, a cathode 103, and an electrolyte 104, with a bipolar plate 105 joining together the anode 102 of one corrosion test cell 101 to the cathode 103 of the next test cell 101. Although depicted as a plurality of corrosion test cells 101, it will be appreciated that the corrosion test cell system 100 may comprise a single corrosion test cell 101 that might be of interest to a user. The corrosion test cell stack may have as many corrosion test cells 101 as needed to operate for the intended application. This is also applicable to other electrochemical systems like fuel cells or electrolyzers, among others, that are of interest to the user.

The present disclosure contemplates that the components of the corrosion test cell system 100 may be of any suitable size or shape as needed for the intended application. For example, as depicted in FIGS. 1A-1C, in some embodiments, various components of the corrosion test cell system 100, including the bipolar plates 105, may be square. In still other embodiments, the bipolar plate 105 and/or other components may be elongated, rectangular, circular, etc.

Referring to FIGS. 1A-1C, the corrosion test cell system 100 comprises one or more transducers 110. A transducer 110 is an acoustic excitation device. The transducers 110 can emit sound waves according to one or more ultrasonic frequencies. In some embodiments, a first transducer 101A is coupled to an external surface of the corrosion test cell system 100 as depicted in FIGS. 1A-1C. In some examples, the first transducer 101A may be mounted or attached using clamps, clamping systems, straps, wax, adhesives, and/or the like. Although depicted as an array of first transducers 110A approximately centrally positioned on the external surface of the corrosion test cell system 100, it will be appreciated that the first transducer(s) 110A may be positioned, internally or externally, in any position on the surface of the corrosion test cell system 100 that might be of interest to a user. Similarly, although depicted as an array of first transducers 110A, it will be appreciated that a single transducer 110 may be positioned on the surface of the corrosion test cell system 100. In some embodiments, an array of first transducers 110 may provide a more comprehensive view of the internal components of the corrosion test cell system 100. It is not necessary for the first transducer(s) 101A, operating as a pulse-echo transducer as discussed herein, to be in physical contact with the layers (e.g., bipolar plate(s) 105) and can be placed on the outside or outside layer of the corrosion test cell stack.

In some embodiments, such first transducer 110A may be configured to emit a pulse sequence into the corrosion test cell system 100, perpendicular to the layers (e.g., bipolar plates) of the system 100, and receive a corresponding echo sequence based on a reflection back of the emitted pulse sequence. For example, the first transducer 110A (or array of first transducers 110A) may be an ultrasonic pulse-echo transducer configured to, in a transmitting mode, emit an ultrasonic acoustic pulse sequence into the corrosion test cell system 100 and further configured to, in a receiving mode, receive a corresponding ultrasonic acoustic echo sequence of the emitted ultrasonic acoustic pulse sequence reflected back. Such echo (e.g., reflection signal) may be processed to provide a spectrum including one or more peaks, the position on the x-axis (e.g., time) of each peak indicating a layer (e.g., a bipolar plate 105) in the corrosion test cell system 100. In other words, some embodiments employ ultrasonic pulse-echo, which involves emitting sound waves and analyzing their reflections to identify metallic components and/or the presence of corrosion in such metallic components. In some embodiments, an array of first transducers 110A may be used sending (e.g., transmitting) and receiving the ultrasonic signals. The period of time required for an ultrasonic acoustic pulse (e.g., sound wave) to propagate through the corrosion test cell system and for the acoustic echo reflected off a layer (e.g., bipolar plate(s) 105) to return to the first transducer(s) 110A is measured.

In some embodiments, the ultrasonic acoustic pulse sequence may comprise one or a plurality of ultrasonic pulses. In some embodiments, a series of such ultrasonic acoustic pulse sequences may be emitted and a series of such corresponding ultrasonic acoustic echo sequences may be received for monitoring changes over time in the bipolar plate(s) 105. The emission rate (and corresponding receiving rate) may be application dependent and/or equipment dependent. For example, a highly corrosive environment may require high resolution and equipment capable of emitting and recording signals rapidly in order to monitor fast occurring corrosion, while a slow corrosive environment (e.g., that may take years or decades to corrode) may not require such high resolution or equipment capable of emitting and recording signals as rapidly. For example, in a highly corrosive environment, an ultrasonic pulse may be emitted every 0.1 milliseconds to 10 minutes. For example, an ultrasonic pulse may be emitted about every 0.1 millisecond, every 0.2 millisecond, 0.3 millisecond, every 0.4 millisecond, every 0.5 millisecond, 0.6 millisecond, every 0.7 millisecond, every 0.8 millisecond, 0.9 millisecond, every 1.0 millisecond, every 5.0 milliseconds, every 10.0 milliseconds, every 0.1 second, every 1.0 second, every 2.0 seconds, every 5.0 seconds, every 10.0 seconds, every 30.0 seconds, every 1.0 minute, every 2.0 minutes, every 5.0 minutes, or every 10 minutes. In a slow corrosive environment, an ultrasonic pulse may be emitted every 10 minutes to every year. For example, an ultrasonic pulse may be emitted about every 10 minutes, every 20 minutes, every 30 minutes, every 40 minutes, every 50 minutes, every hour, every 12 hours, every 24 hours, every week, every month, every 2 months, every 3 months, every 6 months, or every year.

As any one or more bipolar plates 105 degrade and change shape during operation (e.g., due to corrosion), changes in the sound wave speed and/or sound travel time as a result of the corrosion can be detected. That is, the peaks will shift to different positions on the x-axis, reflecting changes in the bipolar plate 105. For example, in some embodiments, a peak will shift to the left (e.g., corresponding to an emitted pulse and the corresponding echo response taking less time than a previous scan) the more it corrodes (e.g., thinning of a bipolar plate 105). Accordingly, some example embodiments are configured for detecting differences in echo responses captured by the first transducer 110A. In some embodiments, detecting differences in the echo responses may include determining a first x-axis position of a peak in a first sequence, determining a second x-axis position of the peak in one or more subsequent sequences, wherein the first x-axis position differs from the second x-axis position and determining local corrosion of a corrosion test cell layer, or a layer(s) of any corroding system like fuel cells or electrolyzers, corresponding to the peak based on comparing the first x-axis position to the second x-axis position. In other words, the echo signals are assessed for changes in their signature, the changes reflecting changes in the detected materials, allowing identification of corrosion (or other defects). Each reflection corresponds to a layer, such that pulse-echo methodology identifies how many layers there are and which layer(s), if any, is changing/corroding. In some embodiments, further focusing can be placed on such layer(s) associated with change/corrosion to monitor for further corrosion. In still some embodiments, the corresponding amplitude(s) of the peaks may be analyzed to provide valuable information regarding the corrosion. In still some further embodiments, the corresponding amplitude(s) of the peaks are disregarded from such calculation. In still some embodiments, other peak properties such as, but not limited to, widths, shapes, appearances, and disappearances of the peaks may be analyzed to provide valuable information regarding the corrosion. In still some further embodiments, the corresponding amplitude(s) and one or more of the aforementioned peak properties are disregarded from such calculation.

One or more of the bipolar plates 105 of the corrosion test cell system 100 may comprise a voltage lead tab 106 extending from either side of the bipolar plate 105, each voltage lead tab 106 being accessible externally of the corrosion test cell system 100. It is contemplated by the present disclosure that one or more second transducers 110B may be coupled to one voltage lead tab 106 of a bipolar plate 105 and one or more third transducers 110C may be coupled to another voltage lead tab 106 of the bipolar plate 105. In some embodiments, the second transducer(s) 110B and/or third transducer(s) 110C may be mounted or attached using clamps, clamping systems, straps, wax, adhesives, and/or the like. It is contemplated by this disclosure that the transducers are not limited to being coupled to such voltage lead tab(s). For example, in some embodiments (e.g., as depicted in Example 1), one or more transducers may be coupled to an exposed side of the metallic component, or even submerged under the solution on the side of the metallic component that is corroding.

In this configuration, it is not necessary to disassemble the corrosion test cell system 100 and/or individual corrosion test cells 101, or otherwise require a corrosion test cell manufacturer to redesign the corrosion test cell 101 in order to couple one or more transducers (e.g., the first transducer(s) 110A, the second transducers 110B, and/or the third transducer(s) 110C) to the bipolar plate 105 as portions of the bipolar plate 105 are accessible externally of the corrosion test cell system 100. In other embodiments, one or more transducers (e.g., the first transducer(s) 110A, the second transducers 110B, and/or the third transducer(s) 110C) may be directly attached to the bipolar plate 105 internally of the corrosion test cell system 100.

The second transducer(s) 110B and the corresponding third transducer(s) 110C may be configured to operate in an acoustic resonance method. For example, in a non-limiting example, with the positioning of the second transducer 110B and the third transducer 110C diagonal to each other on each of the two voltage lead tabs 106 of a bipolar plate 105, in some embodiments, one of the second transducer 110B or the third transducer 110C may be configured to excite/resonate/vibrate the bipolar plate 105 across a range of frequencies (e.g., a range of ultrasonic frequencies, any sub-range of which may be dependent on the substrate material of the bipolar plate 105, such as the physical, chemical, and/or mechanical properties and/or shape of the substrate material) and the other transducer of the second transducer 110B or the third transducer 110C may be configured to receive the response of excited bipolar plate 105 across those frequencies. For example, in one embodiment, the second transducer 110B is configured to excite the bipolar plate 105 across a range of frequencies and the third transducer 110C is configured to receive the response of excited bipolar plate 105 across such frequencies. It is contemplated by the present disclosure that the placement or other arrangement of the transducers is not limited to such diagonal/voltage lead tab placement. For example, the transducers need not be in such specific placement at the voltage lead tab or specified to be diagonal from each other, as there may be other locations and/or arrangements that are more convenient or provide improved response.

Such acoustic resonance method is sensitive to changes in the physical, chemical, and mechanical properties as well as shape and surface changes of the bipolar plate 105. Such responses may be culled together to provide a resonance spectrum which includes a series of resonance peaks. As the bipolar plate 105 is degrading and changing shape during operation, such as, but not limited to, loss of metallic ions which may cause thinning of the components or oxide layers thinning or thickening (as they break down or form, respectively), the resonance peaks will shift to different positions. Such shifts in the positioning of the peaks are correlated to changes in the bipolar plate 105. In some embodiments, each (or a plurality) of the bipolar plates 105 of the corrosion test cell system 100 may be coupled to a corresponding second transducer 110B and third transducer 110C, enabling the monitoring of each individual corrosion test cell 101.

It will be appreciated that, while embodiments herein depict and discuss a corrosion test cell and/or corrosion test cell system as an example of a device in which to detect corrosion, nondestructive evaluation of other items is within the scope of the present disclosure.

### Example Methods

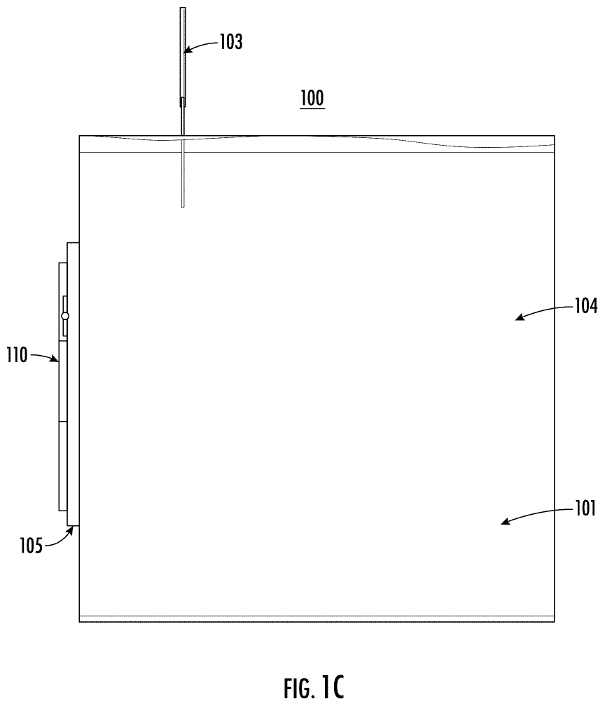

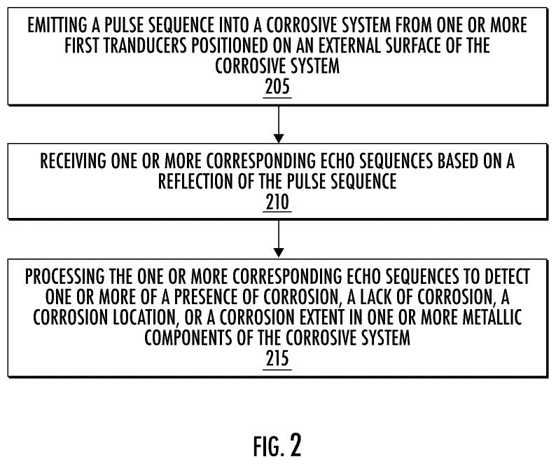

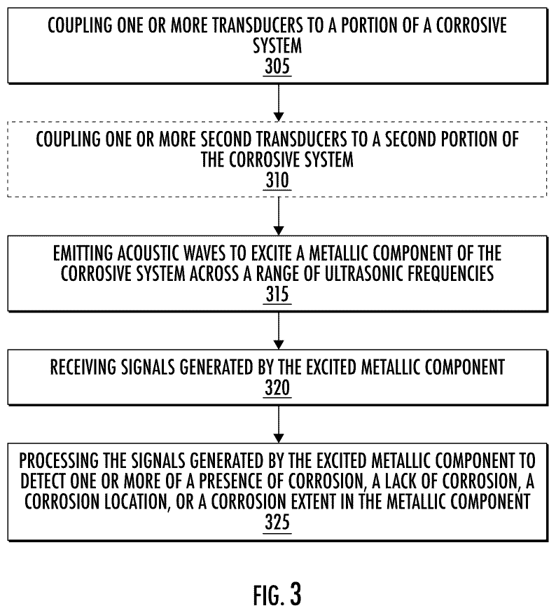

Having described an exemplary corrosive system and ultrasonic corrosion detection in such an exemplary corrosive system, it should be understood that the ultrasonic corrosion detection techniques of the present disclosure may be performed in a number of ways. FIGS. 2 and 3 are flowcharts broadly illustrating a series of steps to perform ultrasonic corrosion detection, for example, of a corrosive system such as the corrosion test cell system 100 as described above.

As shown in FIG. 2, step 205 comprises emitting a pulse sequence into a corrosive system from one or more first transducers positioned on an external surface of the corrosive system. In some embodiments, the one or more first transducers are positioned on a top external surface of the corrosive system while in some other embodiments, the one or more first transducers are positioned on a bottom external surface of the corrosive system. For example, corrosive system may be a metallic container such as a 55-gallon drum containing hazardous waste material and the one or more first transducers may be positioned on the external surface of the metallic 55-gallon drum. In various embodiments, emitting the one or more pulse sequences into the corrosive system comprises emitting the one or more pulse sequences perpendicular to one or more metallic components, such as bipolar plates in a corrosive fuel cell system or the metallic walls or surfaces of a storage container. It is contemplated by the present disclosure that any number of such sending and/or receiving transducers may be used.

In some embodiments, the one or more first transducers are ultrasonic pulse-echo transducers having a transmitting mode and a receiving mode. For example, in some embodiments, the one or more first transducers comprise a single ultrasonic transducer positioned approximately in a center of the top external surface of the corrosive system. In other embodiments, the one or more first transducers comprise an array of ultrasonic transducers. In some embodiments, the pulse sequence is an ultrasonic pulse sequence comprising one or more ultrasonic pulses. In some embodiments, the corrosive system is any one of a variety of corroding systems, including but not limited to, a metallic container, a fuel cell system, a battery, an electrolyzer, a capacitor, a solar cell, an electrochemical cell, or a flow battery. In some embodiments, the corrosive system is a fuel cell system. In some embodiments, the fuel cell system comprises a plurality of fuel cells.

As shown in FIG. 2, step 210 comprises receiving a corresponding echo sequence based on a reflection of the pulse sequence. For example, the method may measure the period of time required for an ultrasonic acoustic pulse (e.g., sound wave) to propagate through the corrosion test cell system and for the acoustic echo reflected off a layer (e.g., bipolar plate(s) in a corrosion test cell) to return to the first transducer. That is, in some embodiments, the one or more corresponding echo sequences are based on a reflection of the pulse sequence on one or more metallic or coated metallic bipolar plates of a corrosion test cell in a corrosion test cell system.

With continued reference to FIG. 2, step 215 comprises processing the corresponding echo sequence to detect one or more of a presence of corrosion, a lack of corrosion, a corrosion location, or a corrosion extent in one or more metallic components of the corrosive system. For example, in some embodiments, processing the one or more corresponding echo sequences comprises detecting differences in the corresponding echo sequences and in still further embodiments, detecting differences in the corresponding echo comprises determining a first x-axis position of a peak in a first sequence, the first x-axis position corresponding to a first travel time, determining a second x-axis position of the peak in one or more subsequent sequences, wherein the second x-axis position corresponds to a second travel time, and wherein the first x-axis position differs from the second x-axis position, and determining local corrosion of a corrosive layer corresponding to the peak based on comparing the first x-axis position to the second x-axis position.

In certain embodiments, determining local corrosion of the corrosive layer corresponding to the peak based on comparing the first x-axis position to the second x-axis position comprises training an algorithm using machine learning to pinpoint a shifting trend in the x-axis positions. For example, the inventors have determined that it would be advantageous to leverage artificial intelligence and train a machine learning model with such dissimilar aggregate of ultrasonic data in order to identify prioritized peak shift trends.

Turning to FIG. 3, another method for non-destructive corrosion detection (e.g., acoustic resonance) in a corrosive system is depicted. In step 305, the method comprises coupling one or more transducers to a portion of a corrosive system, such as a fuel cell system or a metallic storage container storing hazardous material. In some embodiments, at least one of the one or more transducers is configured to emit acoustic waves to excite a metallic component of the corrosive system (such as but not limited to a bipolar plate of a fuel cell or a portion of a metallic container storing hazardous material) across a range of ultrasonic frequencies. In some embodiments, the at least one transducer is also configured to receive signals from the excited metallic component. In some embodiments, the at least one transducer may be coupled to a first voltage lead tab or other portion of the metallic component.

Step 310 includes optionally coupling one or more second transducers to a second portion of the corrosive system, such as a second portion of a bipolar plate in a fuel cell system. For example, in some embodiments, the same transducer is used for both emitting the acoustic waves and receiving the signals from the excited metallic components (e.g., bipolar plates). In such embodiments, a second transducer coupled via step 310 may not be necessary. However, alternatively, in some embodiments, a first transducer (or array of first transducers) may be configured to emit the acoustic waves and a second (separate) transducer (or array of second transducers) may be configured to receive the signals. For example, in some embodiments, the one or more second transducers may be coupled to a second voltage lead tab. In still other embodiments, the second voltage lead tab may be positioned diagonally across the bipolar plate from the first voltage lead tab or first portion of the bipolar plate or other metallic component.

Step 315 includes emitting, by the at least one transducer, the acoustic waves to excite the bipolar plate or other metallic component across a range of ultrasonic frequencies. The specific sub-range of ultrasonic frequencies may be dependent on the material of the metallic component. or coated metallic component.

Step 320 includes receiving the signals generated by the excited metallic component, such as the excited bipolar plate. For example, in some embodiments, the at least one transducer (e.g., the same transducer) is configured and used for both emitting the acoustic waves according to step 315 and receiving the signals from the excited metallic components according to step 320. Alternatively, in some embodiments, the optional second transducer (or array of second transducers) of step 310 may be configured to receive the signals generated by the excited metallic component, separate from the first transducer(s) configured to emit the original acoustic waves.

Step 325 includes processing the signals generated by the excited metallic component to detect one or more of a presence of corrosion, a lack of corrosion, a corrosion location, or a corrosion extent in the metallic component. In some embodiments, processing the signals generated by the excited metallic component, such as a bipolar plate, comprises detecting differences in the signals. In certain embodiments, detecting differences in the signals comprises determining a first x-axis position of a peak in a first signal, the first x-axis position corresponding to a first frequency, determining a second x-axis position of the peak in one or more subsequent signals, wherein the second x-axis position corresponds to a second frequency, and wherein the first x-axis position differs from the second x-axis position, and determining local corrosion of the bipolar plate corresponding to the peak based on comparing the first x-axis position to the second x-axis position. In still further embodiments, determining local corrosion of the bipolar plate corresponding to the peak based on comparing the first x-axis position to the second x-axis position comprises training an algorithm using machine learning to pinpoint a shifting trend in the x-axis positions.

It is contemplated by this disclosure that detecting differences in the signals generated by the excited metallic component is not limited to detecting differences in the x-axis position (e.g., frequency) of signals. For example, many features can be extracted from peaks even if the peak itself is not shifting in the x-axis. For example, appearing and disappearing peaks may reflect corrosion. Similarly, but not limited to, changes in amplitude, peak-broadening, and/or peak-narrowing may also be differences between signals that provide valuable corrosion information.

### EXAMPLES

The following examples are offered by way of illustration and not by way of limitation. Although specific materials and times are depicted and discussed in the Example, other materials and times can be easily substituted to provide a variety of ultrasonic corrosion detections.

### Example

### Preparation of Corrosion Test Cell

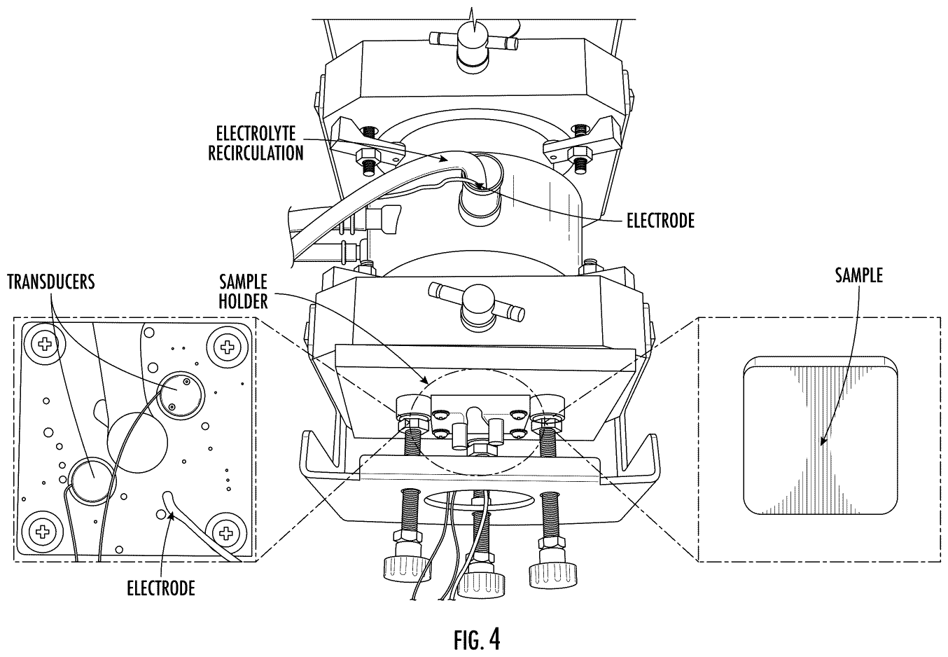

FIG. 4 depicts an example experimental setup to simulate the operating environment of an example corrosive system, such as, but not limited to, a fuel cell or an electrolyzer, and corrode a sample, the example experimental setup including a sample holder, sample, electrode, electrolyte circulation, and transducer placement.

The tests were run on a Proteus standard glass cell (Pine Research). This glass cell contained the electrolyte, which was recirculated during testing. The glass cell also had an inner chamber that allowed for temperature control using glycol and an RTE-211 thermostat (NESLAB Instruments). The sample holder shown in FIG. 4 was located at the end of the glass cell and secured by four screws at each corner. The outer side of the sample holder is enlarged on the left of FIG. 4 and the inner side with the sample is enlarged on the right of FIG. 4.

Two 4 MHz piezoelectric acoustic resonance transducers (emitter and receiver) are affixed to the back (e.g., unexposed to the electrolyte) side of the sample bipolar plate at opposite diagonal corners, although it is contemplated by this disclosure that such placement may be determined by the application, such as, but not limited to, voltage lead tab extending from a bipolar plate of electrochemical systems such as a fuel cell), one acoustic resonance transducer exciting the bipolar plate across a range of frequencies (from 100 kHz to 6 MHz, every two minutes) and the other acoustic resonance transducer receiving the signals of the excited bipolar plate. To induce corrosion, an anode was attached to the sample, while a cathode was inserted into the electrolyte to allow the application of a controlled voltage. The voltage between the electrodes was applied using a DC power source (BK Precision 9111).

### Corrosion Conditions

Two flat, stainless steel bipolar plate samples (SS316, uncoated, Sample A and Sample B, respectively) with overall geometric dimensions of 25.4 mm×25.4 mm×0.71 mm (L×W×T) and with an exposure area to the solution reduced to 4 cm² (2 cm×2 cm) when assembled in the glass cell, were tested using 500 mL of 1 M sodium chloride electrolyte, respectively. In an alternative example, a titanium bipolar plate may be used.

Two different tests/scenarios with varying voltages to induce varying corrosion kinetics were performed and corrosion is detected and monitored as it is induced on the surface of the sample bipolar plates. In a first test/scenario at 30° C., Sample A was subjected to 2.0 V for 60 minutes, followed by application of 1.5 V for 15 minutes (Protocol A). In a second test/scenario at 30° C., Sample B was subjected to 1.5 V for 60 minutes, followed by application of 2.0 V for 15 minutes (Protocol B). The voltage values of 1.5V and 2.0V were selected based on operations for PEMFCs and other electrochemical systems like electrolyzers. The choice of 1.5V is justified by the voltage spikes that occur during the startup and shutdown phases of hydrogen fuel cells. Additionally, the upper limit of 2.0V aligns with the testing range of electrolyzers, which are commonly evaluated within a voltage range of 1.5V to 2.5V. The samples were also weighed before and after testing to quantify the material loss induced by each testing condition.

### Scanning Electron Microscopy (SEM)

A Quattro S Scanning Electron Microscope (Thermo Scientific) was utilized to analyze the surface of the stainless-steel samples before and after testing to analyze surface degradation and material loss induced during the corrosion process at the varying testing conditions. An Everhart-Thornley detector was used to capture images of the samples at 100× and 500× magnification. The working distance was 7.2 mm, while the voltage was set to 10 kV.

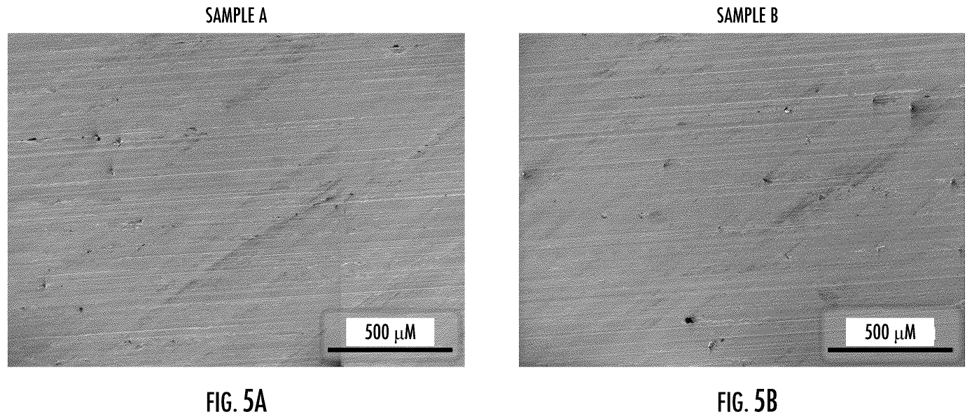

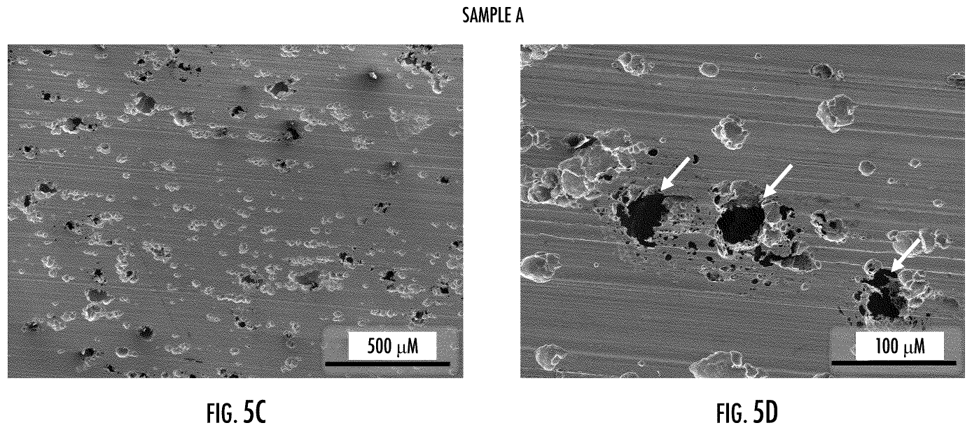

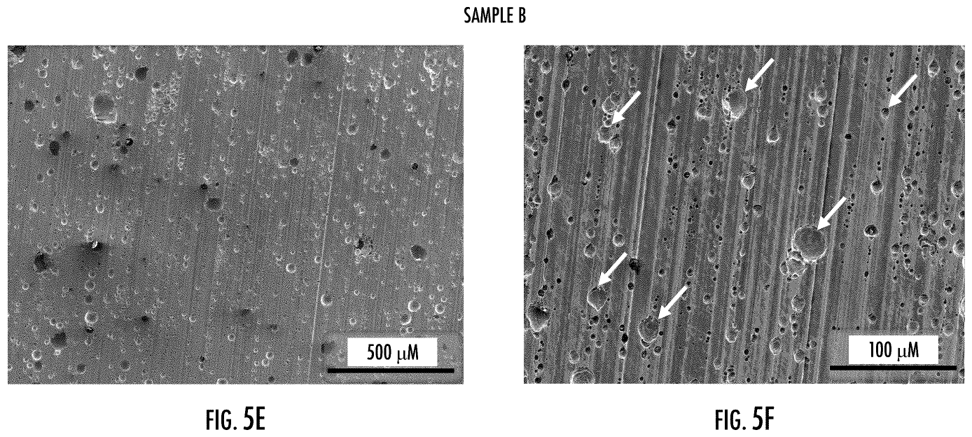

FIGS. 5A and 5B are SEM images of SS316 Samples A and B, respectively, prior to the samples being subjected to the corrosion protocols, illustrating the pristine surfaces of Samples A and B at 100× magnification. FIGS. 5C and 5D are SEM images of Sample A at 100× and 500× magnification, respectively, after subjecting Sample A to Protocol A. FIGS. 5E and 5F are SEM images of SS 316 Sample B at 100× and 500× magnification, respectively, after subjecting Sample B to Protocol B.

FIGS. 5C and 5D reflect clear evidence of deep surface penetration and mass loss of Sample A, as observed in the pores signaled by the arrows depicted in FIG. 5D. A larger number of smaller-sized pits are randomly distributed around the surface of Sample B in FIGS. 5E and 5F, signaled by the arrows depicted in FIG. 5F. The surface degradation of the samples was correlated with their mass loss, which was measured before and after corrosion testing. As reflected in FIGS. 5E and 5F, less pits with high surface penetration are present in Sample B, causing a relatively lower mass loss compared to Sample A, which was anticipated based on the applied voltages. The higher applied voltage in Sample A corresponds to having a higher current in the system, accelerating the corrosion process. The SEM observations are also correlated with the different mass losses due to the leached ions that each sample underwent during corrosion, where Sample A and Sample B had mass reduction of 31.6 mg and 14.7 mg, respectively, corresponding to a ~47% reduction in mass loss from Protocol A to Protocol B.

### Acoustic Resonance Spectroscopy (ARS)

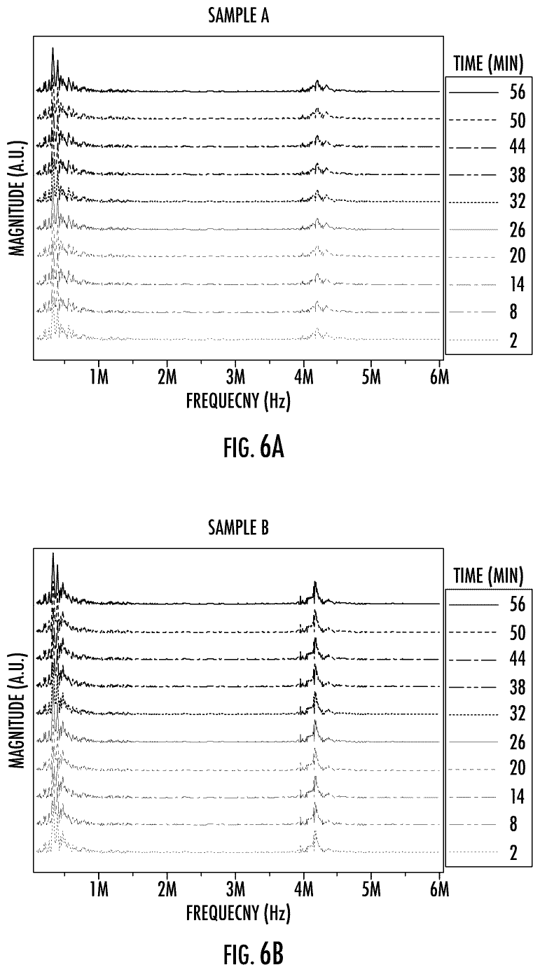

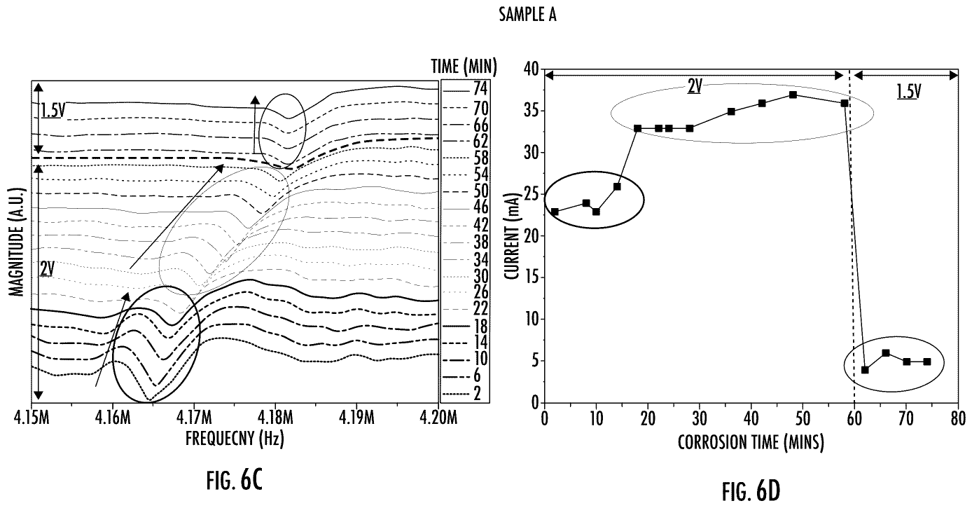

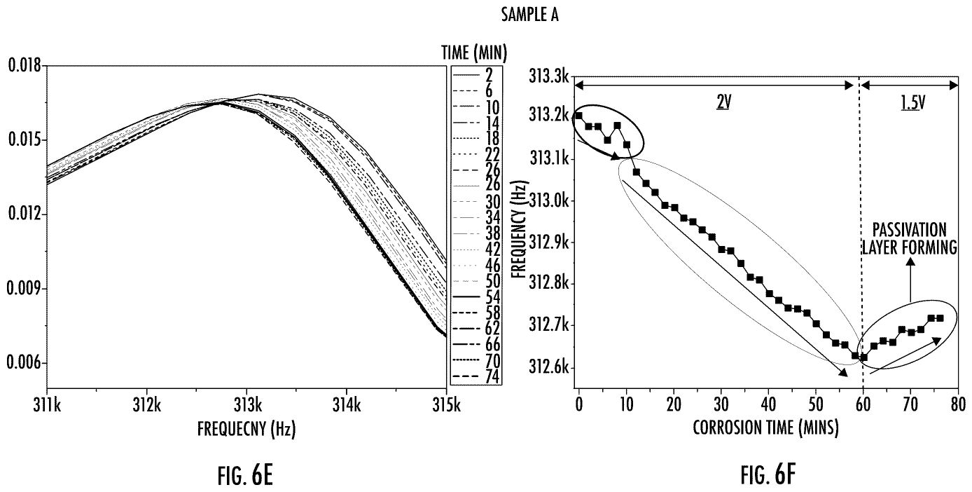

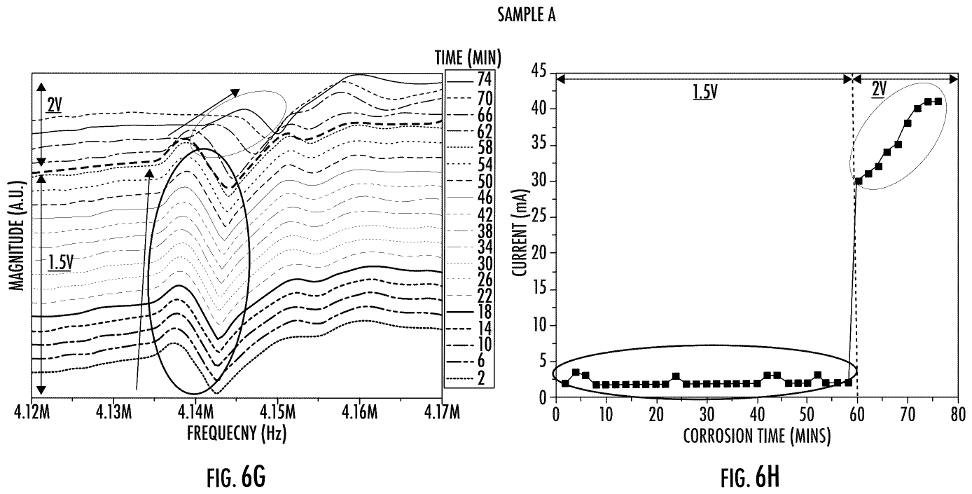

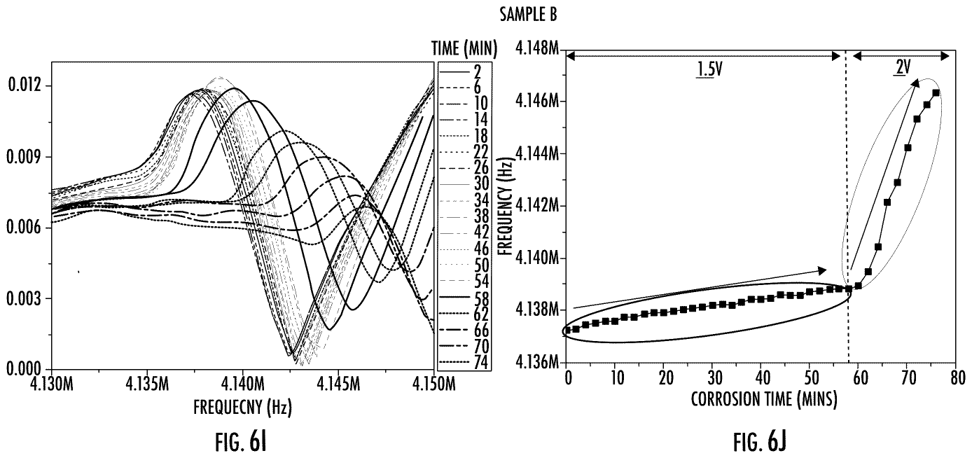

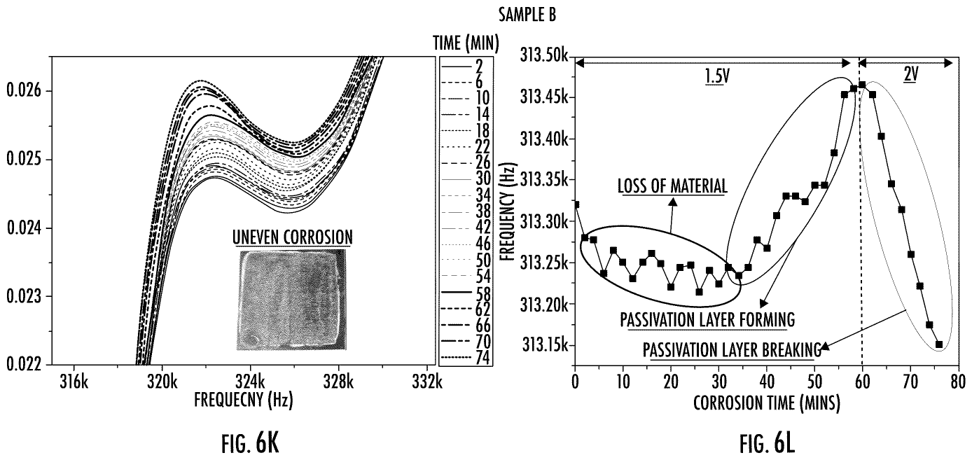

The resonant frequencies of the samples were characterized using a Bode 100 network analyzer (Omicron Lab). The applied voltage across the sample was paused during ARS testing, while the emitter transducer excited the samples from 0.1 to 6 MHz and the receiving transducer detected the response from the samples. The input power was set to 13 dB. The voltage was reapplied after each ARS test was completed. ARS spectra of Samples A and B were measured over time (i.e., a 1-hour period) and are shown in FIGS. 6A and 6B, respectively.

FIG. 6C is an ARS spectra of Sample A between 4.15 and 4.16 MHz during corrosion according to Protocol A. It can be observed that the resonance peak in this region of 4.15 and 4.16 MHz experiences a shift in frequency and magnitude as the sample corrodes. For example, two different kinetics occurred when 2.0V was applied during the first 60 minutes of testing as reflected in the circled regions under the dashed line in FIG. 6C. Then, after the voltage was decreased to 1.5V, these changes in frequency and magnitude considerably slowed down as reflected by the circled region above the dashed line in FIG. 6C. This resonance peak experienced a shift in frequency of ~17 kHz. Since ARS is very sensitive to changes in the shape of the sample, this frequency shift is attributed to changes in the surface of Sample A mainly caused by metallic loss during corrosion. These three distinct kinetics can be directly correlated to the changes in current in the electrochemical cell, which are shown in FIG. 6D. FIG. 6D reflects the measured current in the example electrochemical cell during corrosion of Sample A.

When 2.0V was applied initially to Sample A according to Protocol A, a current between 20-25 mA was measured, as reflected in the circled region on the left side of FIG. 6D. After 15 minutes of corrosion according to Protocol A, the measured current increased to a range between 33-37 mA, as reflected in the circled region depicted in the top, middle portion of FIG. 6D. This increase in current caused a higher corrosion rate, which is correlated with the increase in the shifting rate of the resonant frequency as previously described in FIG. 6C. When reducing the voltage from 2.0V to 1.5V after 60 minutes of corrosion time according to Protocol A, the current decreased to a range between 3-6 mA, as reflected in the circled region depicted in the lower, right corner of FIG. 6D, which caused a significant reduction in the corrosion rate depicted in the circled region above the dashed line in FIG. 6C. The three currents in FIG. 6D are directly correlated to the three different resonance frequency shifting kinetics from FIG. 6C, demonstrating that ARS can be utilized in example embodiments of the present disclosure to in-situ monitor changes in the rate of corrosion in the sample with varying currents.

FIG. 6E is the ARS spectra of Sample A between 311 and 315 kHz during corrosion according to Protocol A. The center frequency location of this resonance peak with respect to corrosion time is graphed in FIG. 6F. Once again, three different shifting kinetics are observed. When 2.0V was applied during the first 60 minutes according to Protocol A, two different kinetics occurred, where the decreasing rate in frequency shift increased after 15 minutes, as reflected in the two circled regions on the left side of the dashed vertical line in FIG. 6F. Similar to the resonant frequency discussed with respect to FIGS. 6C and 6D, these trends correlate to the measured current in the electrochemical cell shown previously in FIG. 6D. As the current increases, the metallic loss on the surface of the sample increases, which is observed in the circled region in the middle of FIG. 6F. On the other hand, a noticeable change in trend is observed when the voltage was reduced from 2.0V to 1.5V. As reflected in the circled region to the right of the vertical dashed lined in FIG. 6F, there is a reversal trend in the resonant mode, which starts increasing in frequency, suggesting that material buildup may have occurred at the surface location where this resonant frequency is dependent. Without being bound by any particular theory, this may be explained by the formation of a local passivation layer, which is an oxide layer that acts as a barrier to prevent further corrosion, aided by specific electrochemical conditions at that location when the voltage and current were reduced. Local corrosion and currents have been reported previously in corroding metals, where localized parts of the sample experience different corrosion currents causing uneven corrosion throughout the sample's surface.

FIG. 6G contains the ARS spectra of Sample B between 4.12 and 4.17 MHz during corrosion according to Protocol B. Similar to Sample A, it can be observed that the resonance peak in this region experiences a shift in frequency and magnitude as Sample B corrodes. When applying 1.5V during the first 60 minutes, a slow, constant increase in the resonant frequency is obtained as reflected by the circled region below the dashed line in FIG. 6G. This is correlated to having a slow, steady loss of material on the surface of the sample when having a low current between 2-4 mA, as reflected in the circled region located toward the bottom of FIG. 6H. When increasing the voltage to 2.0V for 15 minutes according to Protocol B, the current exponentially increased to 30 mA and continued to increase up to 41 mA during those 15 minutes, as reflected by the circled region in the upper right portion of FIG. 6H. An exponential increase in the kinetics of the frequency shift is observed in FIG. 6G, which is caused by a much rapid material loss in the surface of Sample B due to the higher current in the electrochemical cell. This behavior is reflected in the circled region located above the dashed line in FIG. 6G. ARS shows that applying a higher voltage accelerates the corrosion rate, corroborating the results obtained for Sample A discussed herein.

The resonance peak reflected in the circled region below the dashed line of FIG. 6G is plotted in more detail in the ARS spectra of FIG. 6I. A steady shift in peak frequency is observed during the first 60 minutes of corrosion while increasing the voltage from 1.5V to 2.0V, accelerating the peak-shift kinetics. In addition, a decrease in the magnitude of the resonance peak emphasizes the changes occurring on the surface of Sample B (i.e. material loss) when it is subjected to a higher voltage. The center frequency location of this resonance peak is graphed in FIG. 6J. It is observed that when there is a low current during the first 60 minutes, as shown in FIG. 6G, there is a steady increase in the resonant frequency of 1.7 kHz, as reflected in the circled region to the left of the vertical dashed line in FIG. 6J. An increase of 7.4 kHz is observed during the following 15 minutes when the voltage was increased to 2.0V according to Protocol B, as reflected in the circled region on the right side of the vertical dashed line of FIG. 6J. Such exponential increase is also correlated with the higher current in the electrochemical cell when 2.0V was applied (FIG. 6H).

FIG. 6K contains the ARS spectra of Sample B between 316 and 332 kHz during corrosion according to Protocol B and the center frequency location of this resonance peak is graphed in FIG. 6L. Unlike the resonance analyzed in FIGS. 6I and 6J, three different kinetics are observed in FIGS. 6K and 6L. First, a decrease in the frequency of the resonance peak is observed caused by a slow surface material loss, as reflected in the circled region on the left side of FIG. 6L. A change in trend is observed where the frequency of the resonance peak increased after ~35 minutes of corrosion at 1.5V, as reflected by the circled region in the central portion of FIG. 6L. Without being bound by any particular theory, similar to the resonance peak previously analyzed of Sample A at ~313 kHz in FIGS. 6E and 6F, this change in trend may be attributed to a local passivation layer formation at the surface of Sample B where this resonance peak is dependent. It can be visually observed in the insert in FIG. 6K that uneven corrosion is present on the surface of Sample B, which may be caused by localized voltages. This can cause acoustic resonances of the sample to behave differently as the sample's surface corrodes at varying rates. Finally, after increasing the voltage to 2.0V according to Protocol B, thus exponentially increasing the current as reflected in the circled region in the upper right portion of FIG. 6H, the original trend is recovered where the resonance frequency decreases in frequency, as reflected in the circled region located to the right of the vertical dashed line in FIG. 6L. This time, however, the decreasing trend is much higher than at the beginning of corrosion (i.e., the circled region on the left side of FIG. 6L). Without being bound by any particular theory, the inventors believe this may have caused the removal of the passivation layer previously formed along with more metal being removed from the surface of Sample B, corroborating the results discussed previously where a higher current increases the corrosion rate, thus causing a higher material loss from the sample's surface that influences the acoustic resonance of the sample. These results demonstrate that, unlike traditional electrochemical characterization methods, example embodiments according to the present disclosure have the capability to detect, in real time, localized corrosion throughout the sample. Traditional electrochemical techniques are not capable of identifying if the corrosion is evenly distributed throughout the sample's surface.

Thus, particular embodiments of the subject matter have been described. While this specification contains many specific implementation details, these should not be construed as limitations on the scope of any embodiments or of what may be claimed, but rather as description of features specific to particular embodiments of the present disclosure. Other embodiments are within the scope of the following claims. It is evident that many alternatives, modifications, and variations will be apparent to those skilled in the art in light of the foregoing description. It is therefore contemplated that the appended claims will embrace any such alternatives, modifications, and variations as falling within the scope and spirit of the present disclosure.

Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while steps or processes are depicted in the drawings in a particular order, this should not be understood as requiring that such steps or processes be performed in the particular order shown or in sequential order, or that all illustrated steps or processes be performed, to achieve desirable results, unless described otherwise. Said differently, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Overview of Terms

For the purposes of the present application, the following explanations of terms are provided to better describe the present disclosure and to guide those of ordinary skill in the art in the practice of the present disclosure:

As used herein, the term “comprising” means including but not limited to and should be interpreted in the manner it is typically used in the patent context. Use of broader terms such as “comprises,” “includes,” and “having” should be understood to provide support for narrower terms such as “consisting of,” “consisting essentially of,” and “comprised substantially of.”

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### Conclusion

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for non-destructive corrosion detection in a corrosive system, the method comprising:
emitting one or more pulse sequences into the corrosive system from one or more first transducers positioned on an external surface of the corrosive system;
receiving one or more corresponding echo sequences based on a reflection of the respective one or more pulse sequences; and
processing the one or more corresponding echo sequences to detect one or more of a presence of corrosion, a lack of corrosion, a corrosion location, or a corrosion extent in one or more metallic components of the corrosive system.

2. The method of claim 1, wherein processing the one or more corresponding echo sequences comprises detecting differences in the corresponding echo sequences.

3. The method of claim 2, wherein detecting differences in the corresponding echo sequences comprises:
determining a first x-axis position of a peak in a first sequence, the first x-axis position corresponding to a first travel time;
determining a second x-axis position of the peak in one or more subsequent sequences, wherein the second x-axis position corresponds to a second travel time, and wherein the first x-axis position differs from the second x-axis position; and
determining local corrosion of a corrosive layer of the corrosive system corresponding to the peak based on comparing the first x-axis position to the second x-axis position.

4. The method of claim 1, wherein one or more first transducers are ultrasonic pulse-echo transducers having a transmitting mode and a receiving mode.

5. The method of claim 1, wherein the corrosive system is a metallic container, fuel cell system, a battery, an electrolyzer, a capacitor, a solar cell, an electrochemical cell, or a flow battery.

6. The method of claim 5, wherein the corrosive system is a fuel cell system.

7. The method of claim 6, wherein the one or more corresponding echo sequences are based on a reflection of the respective one or more pulse sequences on one or more metallic or coated metallic bipolar plates of a fuel cell in the fuel cell system.

8. The method of claim 7, wherein emitting the one or more pulse sequences into the fuel cell system comprises emitting the one or more pulse sequences perpendicular to the one or more metallic or coated metallic bipolar plates.

9. The method of claim 3, wherein determining local corrosion of the corrosive layer corresponding to the peak based on comparing the first x-axis position to the second x-axis position comprises training an algorithm using machine learning to pinpoint a shifting trend in the first and the second x-axis positions.

10. A method for non-destructive corrosion detection in a corrosive system, the method comprising:
coupling one or more transducers to a portion of a corrosive system;
emitting, by at least one of the one or more transducers, acoustic waves to excite a metallic component of the corrosive system across a range of ultrasonic frequencies;
receiving, by at least one of the one or more transducers, signals generated by the excited metallic component; and
processing the signals generated by the excited metallic portion to detect one or more of a presence of corrosion, a lack of corrosion, a corrosion location, or a corrosion extent in the metallic component.

11. The method of claim 10, wherein processing the signals generated by the excited metallic component comprises detecting differences in the signals.

12. The method of claim 11, wherein detecting differences in the signals comprises:
determining a first x-axis position of a peak in a first signal, the first x-axis position corresponding to a first frequency;
determining a second x-axis position of the peak in one or more subsequent signals, wherein the second x-axis position corresponds to a second frequency, and wherein the first x-axis position differs from the second x-axis position;
determining local corrosion of the metallic component corresponding to the peak based on comparing the first x-axis position to the second x-axis position;
determining peak properties of the signals; and
determining local corrosion of the metallic component based on one or more of the determined peak properties.

13. The method of claim 12, wherein determining local corrosion of the metallic component corresponding to the peak based on comparing the first x-axis position to the second x-axis position comprises training an algorithm using machine learning to pinpoint a shifting trend in the first and the second x-axis positions.

14. The method of claim 10, wherein the same at least one of the one or more transducers is used for the emitting of the acoustic waves and the receiving of the signals.

15. The method of claim 10, wherein emitting, by at least one of the one or more transducers, acoustic waves comprises emitting the acoustic waves by one or more first transducers, and wherein receiving, by at least one of the one or more transducers, signals comprises receiving the signals by one or more second transducers, wherein the first transducer and the second transducer are different transducers.

16. A system for ultrasonic corrosion detection, the system comprising:
one or more metallic components; and
one or more first transducers coupled to an external or internal surface of the system, the one or more first transducers configured to emit one or more pulse sequences into the system and receive one or more corresponding echo sequences based on a reflection of the one or more pulse sequences, the corresponding echo sequences configured to detect one or more of a presence of corrosion, a lack of corrosion, a corrosion location, or a corrosion extent of the one or more metallic components in the system.

17. The system of claim 16, wherein the one or more first transducers are ultrasonic pulse-echo transducers having a transmitting mode and a receiving mode.

18. The system of claim 16, wherein the one or more first transducers are coupled to a top, external surface of the system, the one or more first transducers configured to emit one or more pulse sequences perpendicular to the one or more metallic components.

19. The system of claim 16, wherein each metallic component comprises a first voltage lead tab and a second voltage lead tab, the second voltage lead tab positioned diagonally across the metallic plate from the first voltage lead tab.

20. The system of claim 16, further comprising a plurality of corrosive systems, each corrosive system having at least one metallic component.
